(19) United States
(12) Patent Application Publication
(10) Pub. No.: US 2010/0247775 A1
(43) Pub. Date: Sep. 30, 2010

(54) Precise Fluid Dispensing Method and Device

(75) Inventors: Christopher Allen Thomas, San Leandro, CA (US); Jean-Pierre Babka, San Rafael, CA (US)

Correspondence Address: JACKSON & CO., LLP, 6114 LA SALLE AVENUE, #507, OAKLAND, CA, 94611-2802, US

(73) Assignee: Abbott Diabetes Care Inc., Alameda, CA (US)

(21) Appl. No.: 12/752,109

(22) Filed: Mar. 31, 2010

Related U.S. Application Data
(60) Provisional application No. 61/165,488, filed on Mar. 31, 2009.

(51) Int. Cl. B05D 1/40

(52) U.S. Cl. 427/331

(57) ABSTRACT

Methods and devices include performing a flush routine along a fluid line connectable from a fluid reservoir to a fluid dispensing location of a substrate material, drawing a predetermined fluid from the reservoir through the fluid line, positioning a foot component of a fluid dispensing component on a predetermined dispensing surface relative to the fluid dispensing location, dispensing a predetermined volume of a fluid from the fluid reservoir at the fluid dispensing location on the substrate material, and removing the positioned foot component from the predetermined dispensing surface.

### RELATED APPLICATIONS

The present application claims priority under 35 U.S.C. §119(e) to U.S. provisional application No. 61/165,488 filed Mar. 31, 2009 entitled “Precise Fluid Dispensing Method and Device”, the disclosure of which is incorporated herein by reference in its entirety for all purposes.

### BACKGROUND

Fluid dispensing techniques have evolved with the improvement in dispensing tools that provides for accurate and repeatable control of fluid movement. For example, an important procedure during the manufacturing process for in vivo analyte sensors such as subcutaneous glucose sensors, or in vitro blood glucose test strips, is controlling the dispensing of a very small volume or drop of chemistry (for example 10 to 20 nanoliters (nL)) on the sensor substrate of the sensor or test strip. Variation in the volume of these drops may adversely affect the consistency of the sensor or test strip performance.

It is generally accepted that dispensing such small volume with low dispense-to-dispense ratio (for example, less than 10 percent variation) in a manufacturing environment with a predetermined throughput is a challenge. For example, the higher the variation in the dispense-to-dispense ratio, the lower the manufacturing yield and the lower the consistent sensor or test strip performance.

Existing approaches include the use of piezoelectric (for example, inkjet) or high speed micro-valve approaches. However, piezoelectric approach is generally expensive and fragile, and often prone to clogging, may require modification of components to accommodate small variation in the dispensed fluid properties. Further, the high speed micro-valve approach may not result in the desired low variation in the dispense to dispense ratio of the fluid drop volume. Other approaches include using positive displacement pump systems which may be limited to dispensing fluid with a predetermined viscosity, or the need to replace or modify components of the system to accommodate dispensing volume to a desired level.

### SUMMARY

Embodiments of the subject disclosure include device and methods for providing controlled and repeatable dispensing of a small volume of fluid during analyte sensor manufacturing process with high yield and minimal variation in manufacturing process. For example, embodiments may include performing a flush routine along a fluid line connectable from a fluid reservoir to a fluid dispensing location of a substrate material, drawing a predetermined fluid from the reservoir through the fluid line, positioning a foot component of a fluid dispensing component on a predetermined dispensing surface relative to the fluid dispensing location, dispensing a predetermined volume of a fluid from the fluid reservoir at the fluid dispensing location on the substrate material, and removing the positioned foot component from the predetermined dispensing surface.

Also provided are systems, computer program products, and kits.

### INCORPORATION BY REFERENCE

The following patents, applications and/or publications are incorporated herein by reference for all purposes: U.S. Pat. Nos. 5,264,104; 5,356,786; 5,262,035; 5,320,725; 6,990,366; 7,381,184; 7,299,082; 7,167,818; 7,041,468; 6,942,518; 6,893,545; 6,881,551; 6,773,671; 6,764,581; 6,749,740; 6,746,582; 6,736,957; 6,730,200; 6,676,816; 6,618,934; 6,616,819; 6,600,997; 6,592,745; 6,591,125; 6,560,471; 6,540,891; 6,514,718; 6,514,460; 6,503,381; 6,461,496; 6,377,894; 6,338,790; 6,299,757; 6,284,478; 6,270,455; 6,175,752; 6,161,095; 6,144,837; 6,143,164; 6,134,461; 6,121,009; 6,120,676; 6,071,391; 5,918,603; 5,899,855; 5,822,715; 5,820,551; 5,628,890; 5,601,435; 5,593,852; 5,509,410; 5,320,715; 5,264,014; 5,262,305; 5,262,035; 4,711,245; and 4,545,382; and U.S. Publication Nos. 2009/0018425; 2009/0054749; 2009/0257911 A1; 2009/0281406; 2009/0294277; 2008/0058625; 2008/0064937 A1; 2008/0071157; 2008/0071158; 2008/0179187; 2008/0319295; 2008/0319296; 2007/0149873; 2007/0149875; 2009/0321277; 2010/0030052; and 2004/0186365; and U.S. patent application Ser. No. 12/211,014 filed Sep. 15, 2008; Ser. No. 12/242,780 filed Sep. 30, 2008; Ser. No. 12/393,921 filed Feb. 27, 2009; Ser. No. 12/495,709 filed Jun. 30, 2009; Ser. No. 12/495,712 filed Jun. 30, 2009; Ser. No. 12/495,730 filed Jun. 30, 2009; Ser. No. 12/544,061 filed Aug. 19, 2009; Ser. No. 12/625,185 filed Nov. 24, 2009; Ser. No. 12/625,208 filed Nov. 24, 2009; Ser. No. 12/625,524 filed Nov. 24, 2009; Ser. No. 12/625,525 filed Nov. 24, 2009; Ser. No. 12/625,528 filed Nov. 24, 2009; Ser. No. 12/624,767 filed Nov. 24, 2009; Ser. No. 12/628,177 filed Nov. 30, 2009; Ser. No. 12/628,198 filed Nov. 30, 2009; Ser. No. 12/628,201 filed Nov. 30, 2009; Ser. No. 12/628,203 filed Nov. 30, 2009; Ser. No. 12/628,210 filed Nov. 30, 2009; Ser. No. 12/698,129 filed Feb. 1, 2010; Ser. No. 12/698,124 filed Feb. 1, 2010; Ser. No. 12/699,653 filed Feb. 3, 2010; Ser. No. 12/699,844 filed Feb. 3, 2010; and Ser. No. 12/714,439 filed Feb. 26, 2010; and U.S. Provisional Patent Application No. 61/238,646 filed Aug. 31, 2009.

### BRIEF DESCRIPTION OF THE DRAWINGS

FIG. 1 illustrates an overall system for providing precision fluid dispensing in accordance with one aspect of the present disclosure;

FIG. 2 illustrates a detailed perspective view of the nano pump component of FIG. 1 in accordance with one aspect of the present disclosure;

FIG. 3 is a flowchart illustrating precision fluid dispensing in accordance with one aspect of the present disclosure; and

FIG. 4 is a flowchart illustrating precision dispensing in high volume in accordance with one aspect of the present disclosure.

### DETAILED DESCRIPTION

Before the present disclosure is described in additional detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges is also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described. All publications mentioned herein are incorporated herein by reference to disclose and describe the methods and/or materials in connection with which the publications are cited.

It must be noted that as used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present disclosure is not entitled to antedate such publication by virtue of prior disclosure. Further, the dates of publication provided may be different from the actual publication dates which may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

The figures shown herein are not necessarily drawn to scale, with some components and features being exaggerated for clarity.

Generally, embodiments of the present disclosure relate to methods and systems for precise, high resolution fluid dispensing technique for high yield manufacturing process for in vivo analyte sensors and/or in vitro blood glucose test strips. In other embodiments, the high resolution fluid dispensing device or method may include therapeutic fluid dispensing such as infusion of insulin or other drug.

Example detailed descriptions of embodiments of analyte sensor used in continuous analyte monitoring systems and embodiments of the various components of such monitoring systems are provided in U.S. Pat. No. 6,175,752 issued Jan. 16, 2001 entitled “Analyte Monitoring Device and Methods of Use”, and in application Ser. No. 10/745,878 filed Dec. 26, 2003 entitled “Continuous Glucose Monitoring System and Methods of Use”, the disclosures of each of which are incorporated herein by reference for all purposes.

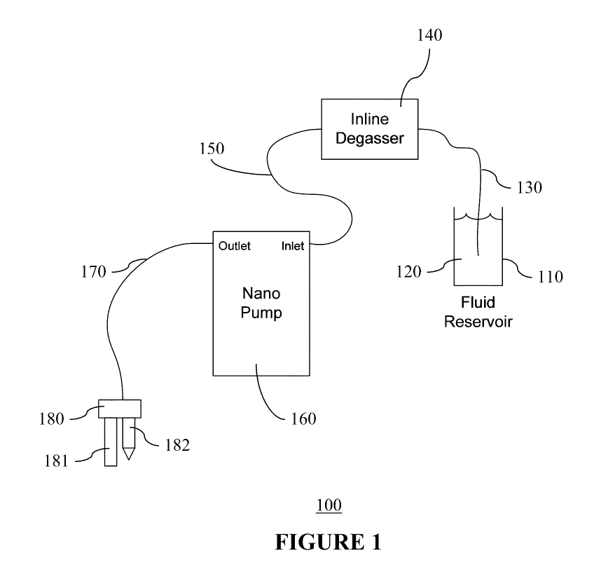

FIG. 1 illustrates an overall system for providing precision fluid dispensing in accordance with one aspect of the present disclosure. Referring to the Figure, the overall fluid dispensing system 100 in one embodiment provides a fluid line from reservoir 110 which contains or houses the suitable dispensing fluid 120 to the dispensing component 180, such as, for example, but not limited to a footed needle. As shown in FIG. 1, the fluid dispensing system 100 includes a plurality of tubing connections 130, 150 and 170, to establish fluid connection between the reservoir 110, an inline degasser 140, nano pump 160 and the dispensing component 180.

As described in further detail below, under the control of one or more processors in the nano pump 160 and/or the inline degasser 140, dispensing fluid 120 is drawn from the reservoir 110 through the inline degasser 140 via tubing connection 130, and provided to an inlet of the nano pump 160 via tubing connection 150, and passed through an outlet of the nano pump 160 to the dispensing component 180 using tubing connection 170. In other embodiments, other components in addition to or in lieu of the nano pump 160 and/or the inline degasser 140 may be used and configured to draw fluid 120 from the fluid reservoir 110 to the dispensing component 180. In still other embodiments, components such as the inline degasser 140 and the nano pump 160 may be integrated into a single unit or housing.

In one aspect, the tubing connection 130 provided between the fluid reservoir 110 and the inline degasser 140 includes a 0.030″ Teflon tubing, while the tubing connection 150 between the inline degasser 140 and the inlet port of the nano pump 160 includes 0.030″ PEEK tubing. Further, the tubing connection 170 between the outlet port of the nano pump 160 and the dispensing component 180 may include 0.010″ PEEK tubing. While specific examples of the tubing connections are described, within the scope of the present disclosure, other suitable tubing connections with different diameters, material and/or length may be used. In one aspect, the tubing connection 170 between the outlet port of the nano pump 160 to the dispensing component 180 may be selected or configured to provide minimized dead volume and/or pressure. Also, gas permeability may be a desirable characteristic for the tubing connection 170 between the outlet port of the nano pump 160 and the dispensing component 180. Within the scope of the present disclosure, other tubing sizes, diameters, dimensions, or types of tubing may be used.

In a further aspect, as shown in FIG. 1, the tubing connections 130 and 150 between the reservoir 110 and the nano pump 160 may be selected or determined based at least in part, on their suitability based on priming and/or bubble in line profile or characteristics.

Referring still to FIG. 1, the dispensing component 180 in one embodiment includes a foot component 181 and a needle component 182, where the foot component 181 is configured to establish a fixed position for the needle component 182 dispensing the fluid 120 from the reservoir 110 relative to the dispensing surface, such as, for example, the substrate or body of an analyte sensor or a blood glucose test strip.

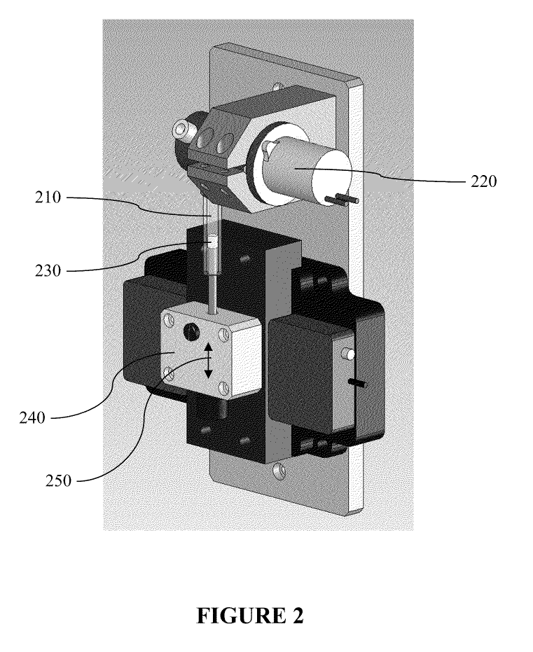

As described in further detail in conjunction with FIG. 2, the needle component 182 of the dispensing component 180 in one embodiment may be configured to dispense or deliver a precise or predetermined volume of fluid 120 from the reservoir 110, under the control of the one or more processors in the nano pump 160 which may be configured to drive a plunger in a syringe barrel of the nano pump 160 to provide the desired fluid dispensing resolution. In one aspect, the nano pump 160 may include an analog encoder which is configured to digitize and convert the analog signal into quadrature signal for the controller or processor of the nano pump 160 such that the nano pump 160 may be configured to provide a dispensing resolution of approximately 0.01 μm/count. In one aspect, with a 25 μL syringe and the plunger configured to travel approximately 30 mm, a volume resolution of approximately 0.0083 nL/count may be attained. While specific examples of the dispensing volume size and resolution is provided herein, within the scope of the present disclosure, other appropriate or suitable configurations of the syringe, plunger and the control logic of the nano pump 160 may be provided to deliver the desired resolution of the dispensing fluid 120.

Referring back to FIG. 1, the inline degasser 140 in one embodiment may be configured to remove or expel gas or air bubbles in the fluid line while maintaining a constant preset vacuum level. For example, in one aspect, solvent is passed through a short length of tubing (for example, Teflon tubing) within a vacuum chamber in the inline degasser 140. A partial vacuum is maintained within the vacuum chamber by, for example, operating (at a steady state) a low RPM (revolution per minute) vacuum pump. In one aspect, the pressure in the vacuum chamber is monitored by one or more control units or logics, including, for example, a microprocessor or a state machine through an integrated absolute pressure sensor.

The solvent that is passed through the short length of the tubing within the vacuum chamber dissolves gases or air bubbles which migrate across the tubing wall (for example, the short length of tubing in the vacuum chamber) under a concentration gradient produced by the vacuum as the solvent passes within the tubing. Gases or air bubbles that are removed are expelled, and the vacuum chamber of the inline degasser 140 is maintained at a constant, preset vacuum or pressure level by varying the vacuum pump speed as needed. In this manner, the fluid 120 from the reservoir 110 in one embodiment is passed through the inline degasser 140 to remove undesirable air bubbles or gases, and thereafter provided to the nano pump 160 for controlled precise volume dispensing using the dispensing component 180.

FIG. 2 illustrates a detailed perspective view of the nano pump component of FIG. 1 in accordance with one aspect of the present disclosure. In one aspect, as shown in FIG. 2, the pumping structure may be provided with a three-way valve 220 which is configured to address failure modes of the pumping mechanism, and is operatively coupled to a syringe 210 which hold the dispensing fluid 120 (FIG. 1) until it is expelled from the syringe 210 via syringe plunger 230 which, in one aspect, is configured to move along the direction of the fluid dispensing as shown by the directional arrow 250. Also provided is a precision stage component 240 which in one embodiment is configured to control the movement of the plunger 230 relative to the syringe 210 to draw the dispensing fluid 120 (FIG. 1) into the syringe 210 from the reservoir 110 (FIG. 1) and to dispense the fluid 120 onto the dispensing surface via the dispensing component 180 (FIG. 1).

For example, in one aspect, as shown in FIG. 2, a syringe 210 mounted to a solenoid-actuated three way valve 220 is coupled to a precision stage 240 which moves the syringe plunger 230 in and out of the syringe 210. In one aspect, the three way valve 220 may be set to an intake position to draw fluid 120 (FIG. 1) from the reservoir 110 (FIG. 1) by drawing the plunger 230 in a downward direction towards the dispensing surface along the direction shown by the directional arrow 250. This movement draws the fluid 120 from the reservoir 110 through the inline degasser 140 and into the syringe 210. Thereafter, when the three way valve 220 is set to an exhaust position, the plunger 230 is configured to move in an upward direction along the direction shown by the directional arrow 250 away from the dispensing surface. In turn, this movement causes the fluid in the syringe 210 to move out of the syringe 210 into the dispensing component 180 (FIG. 1) to be dispensed at the desired or predetermined position over the dispensing surface, for example, via the needle component 182 (FIG. 1)

Referring back to FIGS. 1 and 2, the dispensing component 180 operatively coupled to the syringe 210 of the nano pump 160 includes a foot component 181 and needle component 182. In one embodiment, the foot component 181 is positioned parallel to the needle component 182, where the positioning of the foot component 181 allows the tip end of the needle component 182 to be precisely positioned at a repeatable distance from the dispensing surface when the foot component 181 is placed in contact with the dispensing surface. For example, in one aspect, the foot component 181 is placed on a specific or predetermined location and in contact with the dispensing surface such that, based on the fixed position of the needle component 182 of the dispensing component 180, relative to the foot component 181, the needle component 182 is configured to dispense the desired fluid 120 from the reservoir 110 at the precise or predetermined location on the dispensing surface. In one aspect, the positioning of the foot component 181 relative to the dispensing surface is repeatable with consistency and accuracy such that the location of the fluid dispensing through the needle component 182 is accurately attained or repeated over the dispensing surface.

In this manner, a controlled precise volume of desired fluid such as sensing layer formulation for an in vivo analyte sensor or a in vitro glucose test strip may be provided on the substrate, for example, of the sensor at a precise location during high volume manufacturing to maximize yield and minimize variation in the sensor or test strip characteristics. That is, in one aspect, dispensing the sensing layer formulation may be repeatably attained at the same location on the substrate of each in vivo analyte sensor or in vitro glucose test strip.

In operation, in one aspect, the dispensing system 100 (FIG. 1) undergoes a flush routine using multiple fluids to remove any air bubbles trapped in the system, and to remove or clean out residual fluids which may be along the fluid path in the dispensing system. In one aspect, the types of fluids used may vary depending upon the desired fluid 120 to be dispensed from the reservoir 110. In one embodiment, when the dispensing fluid includes analyte sensor sensing layer formulation, the dispensing system is flushed with alcohol, then with a slug of air, followed by additional alcohol, and thereafter, with deionized water, and finally with the sensing layer formulation.

In one aspect, a flushing routine may be performed using multiple flush cycles of each flushing fluid used or identified, where one flush cycle may be defined as filling the syringe 210 (FIG. 2) with the specified fluid 120 from the reservoir 110 (FIG. 1) to expelling the syringe 210 filled with the fluid through the dispensing component 180. The expelled flushing fluid may then be discarded appropriately. In one aspect, the final flush cycle completes with the syringe 210 filled with the dispensing fluid 120 (for example the sensing layer formulation) to be dispensed through the dispensing component 180.

Turning to the fluid dispensing routine, in one aspect, the three way valve 220 (FIG. 2) is set to the exhaust position and maintained in that position during the duration of the fluid dispensing (or until the syringe 210 runs out of the fluid in which case the dispensing routine is interrupted to refill the syringe 210 with the fluid 120 FIG. 1). When the syringe 210 is filled with the dispensing fluid 120, the dispensing component 180 is positioned to the dispensing location and lowered so that the foot component 181 comes into contact with the dispensing surface, and thus the tip portion of the needle component 182 is positioned at the dispense location.

Referring back to FIGS. 1 and 2, the precision stage component 240 then moves the plunger 230 in the syringe 210 by a preprogrammed or specified distance which corresponds to the volume of the fluid to be dispensed. The movement of the plunger 230 dispenses the fluid out of the tip portion of the needle component 182 of the dispensing component 180 onto the desired dispensing surface at the intended dispensing location. The foot component 181 is then moved away from the dispensing surface so that the foot component 181 is no longer in contact with the dispensing surface, and thereafter, positioned at a new desired location on the next dispensing surface to repeat the dispensing routine. When the dispensing routine is completed, in one aspect, the dispensing system 100 is flushed with deionized water to remove any fluid 120 that may remain in the fluid line.

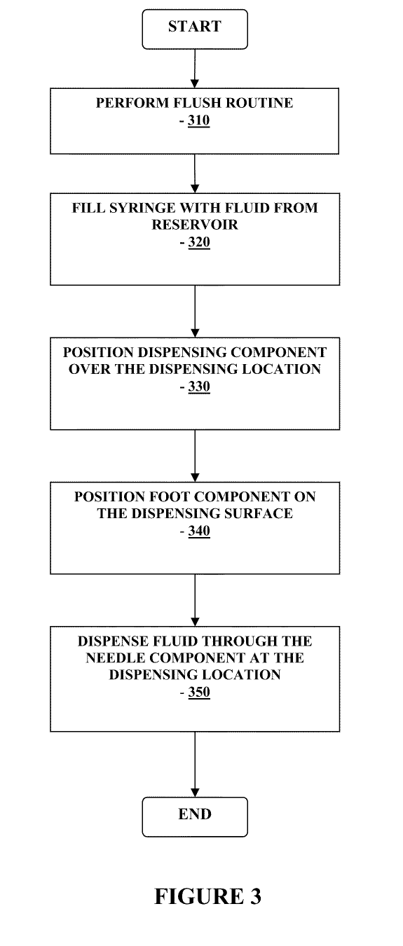

FIG. 3 is a flowchart illustrating precision fluid dispensing in accordance with one aspect of the present disclosure. Referring to FIG. 3, after performing a predefined or programmed flush routine (310), as discussed above, the syringe 210 (FIG. 2) is filled with the fluid 120 (FIG. 1) from the reservoir 110 (320), the fluid 120 comprising the desired fluid for dispensing onto the dispensing surface such as the substrate of the analyte sensor. The dispensing component 180, such as a footed needle, that is in fluid communication with the syringe 210 is positioned at or over the dispensing location of the dispensing surface (330), where the foot component 181 of the dispensing component 180 is positioned in contact with the dispensing surface (340). After precisely positioning the dispensing component 180 and maintaining the position using the foot component 181, the fluid is dispensed through the needle component 182 of the dispensing component 180 at the dispensing location (350).

Within the scope of the present disclosure, one or more of the subroutines described above in conjunction with FIG. 3 may be performed in a different order, or concurrently, or alternatively, may optionally be skipped. That is, in one aspect, the foot component 181 may be positioned on the dispensing surface (340) prior to or concurrently with positioning the needle component 182 of the footed needle/dispensing component 180 relative to the dispensing surface. That is, the foot component 181 and the needle component 182 may be provided in one embodiment in a fixed position relative to each other, such that the positioning of one relative to the dispensing surface, positions the other component relative to the dispensing surface.

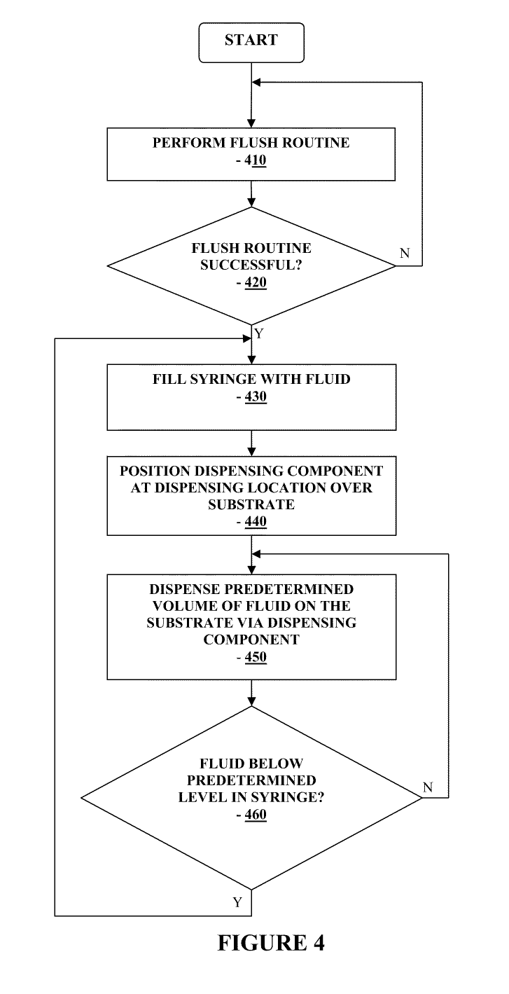

FIG. 4 is a flowchart illustrating precision dispensing in high volume in accordance with one another aspect of the present disclosure. Referring to FIG. 4, a flush routine is performed (410) and thereafter, determined whether the flush routine has been successful (420), for example, in removing the air bubbles and/or gas in the fluid line prior to dispensing the desired fluid. If it is determined that the flush routine is not successful (420), the routine returns to perform the flush routine again. On the other hand, if it is determined that the flush routine is successful (420), then the syringe is filled with the fluid to be dispensed (430), such as sensing layer chemistry formulation, for example, or other material or formulation during the manufacturing of in vivo analyte sensors and/or in vitro glucose test strips.

After filling the syringe with the fluid, the footed needle/dispensing component is positioned at the dispensing location over the substrate surface (440), and thereafter, a predetermined volume of the fluid is dispensed on the substrate via the footed needle/dispensing component (450). Still referring to FIG. 4, after dispensing the predetermined volume of fluid, it is determined whether the sensing layer fluid is below a predetermined level in the syringe (460) which may require a refill of the fluid in the syringe. If it is determined that the fluid level in the syringe falls below the predetermined level, the routine returns to fill the syringe with the sensing layer fluid (430) and the routine repeats. On the other hand, if it is determined that the sensing layer fluid in the syringe does not fall below the predetermined level in the syringe, then the routine returns to dispense the predetermined volume of the sensing layer fluid at the next location on the substrate.

As discussed above, the routines described in conjunction with FIGS. 3 and 4, for example, are configured to yield high throughput during the manufacturing process for manufacturing analyte sensors with low variation in the sensor characteristics potentially attributable to variation in the manufacturing process. In this manner, in one aspect, the fluid dispensing system may be configured to reliably and repeatably place nanoliter sized drops of the fluid needed for sensor fabrication/manufacturing. Additional detailed description of embodiments of analyte sensor manufacturing is provided in U.S. Pat. No. 6,103,033 issued Aug. 15, 2000 entitled “Process for Producing an Electrochemical Biosensor”, the disclosure of which is incorporated herein by reference for all purposes.

In the manner described above, in accordance with embodiments of the present disclosure, a reliable, relatively low cost dispensing method and device that achieved low variation in drop volume (for example, less than approximately 5%) are provided, with improved drop to drop variability fluid dispensing volume, and high throughput for the manufacturing process. Moreover, in accordance with the embodiments of the present disclosure, low volume variation and high throughput in manufacturing process at a low cost may be provided, that are also less prone to clogging, and where the component modification or replacement is not necessary to accommodate changes in the dispensing fluid volume.

In addition, in accordance with aspects of the present disclosure, the dispensing system described herein may be incorporated in a medication delivery device such as external infusion pumps, implantable infusion pumps, and the like for delivery of therapy related fluid such as insulin, glucagon, and the like.

Additionally, in accordance with aspects of the present disclosure, the controlled, repeatable predetermined small volume dispensing of the fluid (such as, but not limited to, analyte sensing formulation, for example) to form analyte sensors such as in vivo glucose sensors, or in vitro blood glucose test strips is provided that consistently and accurately dispenses very small volume of fluid such for example 10 to 20 nanoliters (nL)). Within the scope of the present disclosure, other volume of fluid may be dispenses that may have different resolution such as, for example, less than 10 nL of fluid, or greater than 20 nL of the fluid during the high yield manufacturing process with minimal variation in the sensor characteristics.

The various processes described above including the processes performed by one or more control logics, microprocessors or state machines in the nano pump 160, inline degasser 140 or the precision stage component 240 of the system in the software application execution environment of the overall dispensing system 100 of FIGS. 1 and 2, including the processes and routines described in conjunction with FIGS. 3 and 4, may be embodied as computer programs developed using an object oriented language that allows the modeling of complex systems with modular objects to create abstractions that are representative of real world, physical objects and their interrelationships. The software required to carry out the inventive process, which may be stored in one or more memory or storage device (not shown) of the nano pump 160, inline degasser 140 or the precision stage component 240 of the overall system 100, may be developed by a person of ordinary skill in the art and may include one or more computer program products.

Accordingly, in one aspect, a method includes performing a flush routine along a fluid line connectable from a fluid reservoir to a fluid dispensing location of a substrate material, drawing a predetermined fluid from the reservoir through the fluid line, positioning a foot component of a fluid dispensing component on a predetermined dispensing surface relative to the fluid dispensing location, dispensing a predetermined volume of a fluid from the fluid reservoir at the fluid dispensing location on the substrate material, and removing the positioned foot component from the predetermined dispensing surface.

In one aspect, performing the flush routine may include removing one or more air bubbles in the fluid line.

In another aspect, performing the flush routine may include removing residual fluid in the fluid line.

In a further aspect, performing the flush routine may include passing one or more of alcohol, air, deionized water, or one or more combinations thereof through the fluid line.

In still another aspect, performing the flush routine may include priming the fluid line.

The predetermined fluid drawn from the reservoir may include an analyte sensing formulation.

Also, embodiments may include repeating the positioning, dispensing and removing steps at a plurality of fluid dispensing locations on the substrate material, such that the dispensed predetermined volume of fluid is substantially identical.

The dispensed volume of fluid in one embodiment may be less than approximately 20 nL.

A fluid dispensing system in accordance with another aspect of the present disclosure includes a reservoir for retaining a predetermined type of fluid, a pumping mechanism in fluid contact with the reservoir to selectively dispense a predetermined volume of fluid from the reservoir, and a dispensing component in fluid communication with the pumping mechanism for dispensing a plurality of the predetermined volume of fluid from the reservoir, each predetermined volume dispensed at a corresponding position on a surface of a substrate material, where the dispensing component includes a foot component and a needle component in a fixed position relative to the dispensing component, the foot component configured to contact the surface of the substrate material prior to each predetermined volume dispensed at the corresponding position on the surface of the substrate material, and further where the needle component is configured to dispense each predetermined volume of fluid on the substrate material.

The dispensing component may include a footed needle.

The pumping mechanism may include a priming component to prime the fluid path from the reservoir to the needle component.

In yet still another aspect, the priming component may include an inline degasser module fluidly coupled between the reservoir and the dispensing component.

Further, the priming component may be configured to remove one or more air bubbles or residual fluid in the fluid path between the reservoir and the dispensing component.

Moreover, the priming component may be configured to pass one or more of alcohol, air, de-ionized water, the fluid from the reservoir or combinations thereof in a predetermined sequence.

In still another embodiment, the pumping mechanism may include a syringe fluidly coupled to the reservoir to receive the fluid from the reservoir prior to dispensing a predetermined volume of the fluid.

The fluid in the reservoir may include an analyte sensing formulation or saline solution.

The dispensed predetermined volume of fluid may be less than approximately 20 nL.

Also, in aspects of the present disclosure, there may be provided a control unit operatively coupled to the pumping mechanism and the dispensing component to control dispensing of the predetermined volume of fluid on the substrate material. Examples of such control unit include, but not limited to one or more microprocessors, application specific integrated circuits (ASIC), or one or more memory or storage unit (volatile and/or non-volatile).

Various other modifications and alterations in the structure and method of operation of this disclosure will be apparent to those skilled in the art without departing from the scope and spirit of the embodiments of the present disclosure. Although the present disclosure has been described in connection with particular embodiments, it should be understood that the present disclosure as claimed should not be unduly limited to such particular embodiments. It is intended that the following claims define the scope of the present disclosure and that structures and methods within the scope of these claims and their equivalents be covered thereby.

What is claimed is:

1. A method, comprising:
performing a flush routine along a fluid line connectable from a fluid reservoir to a fluid dispensing location of a substrate material;
drawing a predetermined fluid from the reservoir through the fluid line;
positioning a foot component of a fluid dispensing component on a predetermined dispensing surface relative to the fluid dispensing location;
dispensing a predetermined volume of a fluid from the fluid reservoir at the fluid dispensing location on the substrate material; and
removing the positioned foot component from the predetermined dispensing surface.

2. The method of claim 1 wherein performing the flush routine includes removing one or more air bubbles in the fluid line.

3. The method of claim 1 wherein performing the flush routine includes removing residual fluid in the fluid line.

4. The method of claim 1 wherein performing the flush routine includes passing one or more of alcohol, air, deionized water, or one or more combinations thereof through the fluid line.

5. The method of claim 1 wherein performing the flush routine includes priming the fluid line.

6. The method of claim 1 wherein the predetermined fluid drawn from the reservoir includes an analyte sensing formulation.

7. The method of claim 1 including repeating the positioning, dispensing and removing steps at a plurality of fluid dispensing locations on the substrate material, such that the dispensed predetermined volume of fluid is substantially identical.

8. The method of claim 1 wherein the dispensed volume of fluid is less than approximately 20 nL.

9. A fluid dispensing system, comprising:
a reservoir for retaining a predetermined type of fluid;
a pumping mechanism in fluid contact with the reservoir to selectively dispense a predetermined volume of fluid from the reservoir; and
a dispensing component in fluid communication with the pumping mechanism for dispensing a plurality of the predetermined volume of fluid from the reservoir, each predetermined volume dispensed at a corresponding position on a surface of a substrate material;
wherein the dispensing component includes a foot component and a needle component in a fixed position relative to the dispensing component, the foot component configured to contact the surface of the substrate material prior to each predetermined volume dispensed at the corresponding position on the surface of the substrate material, and further
wherein the needle component is configured to dispense each predetermined volume of fluid on the substrate material.

10. The system of claim 9 wherein the dispensing component includes a footed needle.

11. The system of claim 9 wherein the pumping mechanism includes a priming component to prime the fluid path from the reservoir to the needle component.

12. The system of claim 11 wherein the priming component includes an inline degasser module fluidly coupled between the reservoir and the dispensing component.

13. The system of claim 11 wherein the priming component is configured to remove one or more air bubbles or residual fluid in the fluid path between the reservoir and the dispensing component.

14. The system of claim 9 wherein the priming component is configured to pass one or more of alcohol, air, deionized water, the fluid from the reservoir or combinations thereof in a predetermined sequence.

15. The system of claim 9 wherein the pumping mechanism includes a syringe fluidly coupled to the reservoir to receive the fluid from the reservoir prior to dispensing a predetermined volume of the fluid.

16. The system of claim 9 wherein the fluid in the reservoir includes one or more of analyte sensing formulation or saline solution.

17. The system of claim 9 wherein the dispensed predetermined volume of fluid is less than approximately 20 nL.

18. The system of claim 9 including a control unit operatively coupled to the pumping mechanism and the dispensing component to control dispensing of the predetermined volume of fluid on the substrate material.
